(19) United States
(12) Patent Application Publication
(10) Pub. No.: US 2014/0258591 A1
(43) Pub. Date: Sep. 11, 2014

(54) DATA STORAGE AND RETRIEVAL IN A HYBRID DRIVE

(71) Applicant: KABUSHIKI KAISHA TOSHIBA, Tokyo (JP)

(72) Inventor: Eric R. DUNN, Cupertino, CA (US)

(73) Assignee: Kabushiki Kaisha Toshiba, Tokyo (JP)

(21) Appl. No.: 13/789,631

(22) Filed: Mar. 7, 2013

(51) Int. Cl. G06F 12/02

(52) U.S. Cl. CPC G06F 12/0246
USPC 711/103

(57) ABSTRACT

A data storage device includes a magnetic storage device and a non-volatile solid-state memory device. The addressable space of the non-volatile solid-state storage device is partitioned into a plurality of equal sized segments and the addressable space of a command to read or write data to the data storage device is partitioned into a number of equal sized sets of contiguous addresses, such that each set of contiguous addresses has the same size as a segment of the addressable space of the non-volatile solid-state storage device. Storage can be allocated in the non-volatile solid-state device for selected sets of the contiguous addresses by mapping each selected set to a specific segment of the addressable space of the non-volatile solid-state device.

### BACKGROUND

1. Field

Embodiments described herein relate generally to data storage units, systems, and methods for storing data in a disk drive.

2. Description of the Related Art

A hard disk drive is a commonly used data storage device for computers and other electronic devices, and primarily stores digital data in concentric tracks on the surface of a data storage disk. The data storage disk is a rotatable hard disk with a layer of magnetic material thereon, and data are read from or written to a desired track on the data storage disk using a read/write head that is held proximate to the track while the disk spins about its center at a constant angular velocity. Data are read from and written to the data storage disk in accordance with read and write commands transferred to the hard disk drive from a host computer.

Generally, hard disk drives include a data buffer, such as a small random-access memory, for temporary storage of selected information. Such a data buffer is commonly used to store read and write commands received from a host computer, so that said commands can be arranged in an order that can be processed by the drive much more quickly than processing each command in the order received. Also, a data buffer can be used to cache data that is most frequently and/or recently used by the host computer. In either case, the larger the size of the data buffer, the more that disk drive performance is improved. However, due to cost and other constraints, the storage capacity of the data buffer for a hard disk drive is generally very small compared to the storage capacity of the associated hard disk drive. For example, a 1 TB hard disk drive may include a DRAM data buffer having a storage capacity of 8 or 16 MB, which is on the order of a thousandth of a percent of the hard disk storage capacity.

With the advent of hybrid drives, which include magnetic media combined with a sizable non-volatile solid-state memory, such as NAND-flash, it is possible to utilize the non-volatile solid-state memory as a very large cache. Non-volatile solid-state memory in a hybrid drive may have as much as 10% or more of the storage capacity of the magnetic media, and can potentially be used to store a large quantity of cached data and re-ordered read and write commands, thereby greatly increasing disk drive performance.

Unfortunately, conventional techniques for caching data are not easily extended to such a large-capacity storage volume. For example, using a table to track whether each logical block address of the 1 TB hard disk drive storage space is also stored in the non-volatile solid-state memory and at what physical location in the non-volatile solid state memory they are stored requires an impractically large DRAM buffer for the hard disk drive. Furthermore, use of such a table can result in impractically time-consuming overhead in the operation of the hard disk drive, since said table is consulted for each read or write command received by the hard disk drive. Consequently, systems and methods that facilitate the use of a non-volatile solid-state memory as a memory cache in a hybrid drive are generally desirable.

### SUMMARY

One or more embodiments provide systems and methods for data storage and retrieval in a data storage device that includes a magnetic storage medium and a non-volatile solid-state device. According to the embodiments, the addressable space of the non-volatile solid-state storage device is partitioned into a plurality of equal sized segments and the addressable space of a command to read or write data to the data storage device is partitioned into a number of equal sized sets of contiguous addresses, such that each set of contiguous addresses has the same size as a segment of the addressable space of the non-volatile solid-state storage device. Storage can be allocated in the non-volatile solid-state device for selected sets of the contiguous addresses by mapping each selected set to a specific segment of the addressable space of the non-volatile solid-state device. This mapping facilitates the use of the non-volatile solid-state device as a memory cache for the magnetic storage medium, since the determination can be quickly made whether or not any particular set of contiguous addresses is mapped to a logical segment of the non-volatile solid-state device.

A method of performing an operation on a data storage device including a non-volatile solid state storage device and a magnetic storage device in response to a command to read or write a data block, according to one embodiment, comprises partitioning an addressable space of the non-volatile solid state storage device into a plurality of equal sized segments, each segment having a size that is bigger than a size of the data block and maintaining a mapping of an addressable space of the command to the segments, the addressable space of the command including an address of the data block. The method further comprises determining from the mapping whether or not the address of the data block is mapped to one of the segments and executing the command based on said determining.

A data storage device according to an embodiment comprises a magnetic storage device, a non-volatile solid-state device, and a controller. The controller is configured to, in response to a command to read a data block, partition an addressable space of the non-volatile solid state storage device into a plurality of equal sized segments, each segment having a size that is bigger than a size of the data block, maintain a mapping of an addressable space of the command to the segments, the addressable space of the command including an address of the data block, and execute the command to read the data block based on whether or not the address of the data block is mapped to one of the segments.

A data storage device according to another embodiment comprises a magnetic storage device, a non-volatile solid-state device, and a controller. The controller is configured to, in response to a command to write a data block, partition an addressable space of the non-volatile solid state storage device into a plurality of equal sized segments, each segment having a size that is bigger than a size of the data block, maintain a mapping of an addressable space of the command to the segments, the addressable space of the command including an address of the data block, and execute the command to write the data block based on whether or not the address of the data block is mapped to one of the segments.

### BRIEF DESCRIPTION OF THE DRAWINGS

So that the manner in which the above recited features of embodiments can be understood in detail, a more particular description of various embodiments, briefly summarized above, may be had by reference to the appended drawings. It is to be noted, however, that the appended drawings illustrate only typical embodiments and are therefore not to be considered limiting of its scope, for the invention may admit to other equally effective embodiments.

FIG. 1 is a schematic view of an exemplary disk drive, according to one embodiment.

FIG. 2 illustrates an operational diagram of a disk drive with elements of electronic circuits shown configured according to one embodiment.

FIG. 3 is a conceptual illustration of a mapping structure, according to some embodiments.

FIG. 4 is a tabular representation of a logical-to-physical mapping function between cache entries and physical addresses in a flash memory device, according to some embodiments.

FIG. 5 sets forth a flowchart of method steps for data storage or retrieval in a hybrid drive, according to one or more embodiments.

For clarity, identical reference numbers have been used, where applicable, to designate identical elements that are common between figures. It is contemplated that features of one embodiment may be incorporated in other embodiments without further recitation.

### DETAILED DESCRIPTION

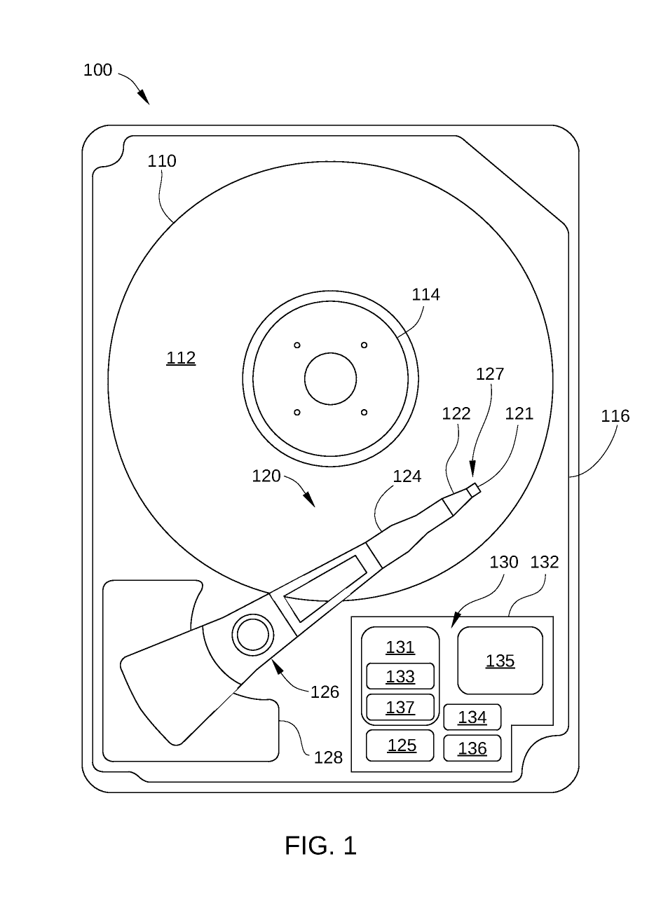

FIG. 1 is a schematic view of an exemplary disk drive, according to one embodiment. For clarity, hybrid drive 100 is illustrated without a top cover. Hybrid drive 100 includes at least one storage disk 110 that is rotated by a spindle motor 114 and includes a plurality of concentric data storage tracks. Spindle motor 114 is mounted on a base plate 116. An actuator arm assembly 120 is also mounted on base plate 116, and has a slider 121 mounted on a flexure arm 122 with a read/write head 127 that reads data from and writes data to the data storage tracks. Flexure arm 122 is attached to an actuator arm 124 that rotates about a bearing assembly 126. Voice coil motor 128 moves slider 121 relative to storage disk 110, thereby positioning read/write head 127 over the desired concentric data storage track disposed on the surface 112 of storage disk 110. Spindle motor 114, read/write head 127, and voice coil motor 128 are coupled to electronic circuits 130, which are mounted on a printed circuit board 132. Electronic circuits 130 include a read/write channel 137, a microprocessor-based controller 133, random-access memory (RAM) 134 (which may be a dynamic RAM and is used as a data buffer), and a flash memory device 135 and flash manager device 136. In some embodiments, read/write channel 137 and microprocessor-based controller 133 are included in a single chip, such as a system-on-chip 131. In some embodiments, hybrid drive 100 may further include a motor-driver chip 125, which accepts commands from microprocessor-based controller 133 and drives both spindle motor 114 and voice coil motor 128. For clarity, hybrid drive 100 is illustrated with a single storage disk 110 and a single actuator arm assembly 120. Hybrid drive 100 may also include multiple storage disks and multiple actuator arm assemblies. In addition, each side of storage disk 110 may have an associated read/write head coupled to a flexure arm.

When data are transferred to or from storage disk 110, actuator arm assembly 120 sweeps an arc between an inner diameter (ID) and an outer diameter (OD) of storage disk 110. Actuator arm assembly 120 accelerates in one angular direction when current is passed in one direction through the voice coil of voice coil motor 128 and accelerates in an opposite direction when the current is reversed, thereby allowing control of the position of actuator arm assembly 120 and attached read/write head 127 with respect to storage disk 110. Voice coil motor 128 is coupled with a servo system known in the art that uses the positioning data read from servo wedges on storage disk 110 by read/write head 127 to determine the position of read/write head 127 over a specific data storage track. The servo system determines an appropriate current to drive through the voice coil of voice coil motor 128, and drives said current using a current driver and associated circuitry.

Hybrid drive 100 is configured as a hybrid drive, in which non-volatile data storage can be performed using storage disk 110 and flash memory device 135, which is an integrated non-volatile solid-state memory device. In a hybrid drive, non-volatile solid-state memory, such as flash memory device 135, supplements the spinning storage disk 110 to provide faster boot, hibernate, resume and other data read-write operations, as well as lower power consumption. Such a hybrid drive configuration is particularly advantageous for battery operated computer systems, such as mobile computers or other mobile computing devices.

In some embodiments, flash memory device 135 is a non-volatile solid state storage medium, such as a NAND flash chip that can be electrically erased and reprogrammed, and is sized to supplement storage disk 110 in hybrid drive 100 as a non-volatile storage medium. For example, in some embodiments, flash memory device 135 has data storage capacity that is orders of magnitude larger than RAM 134, e.g., gigabytes (GB) vs. megabytes (MB). Consequently, flash memory device 135 can be used to cache a much larger quantity of data that is most recently and/or most frequently used by a host device associated with hybrid drive 100.

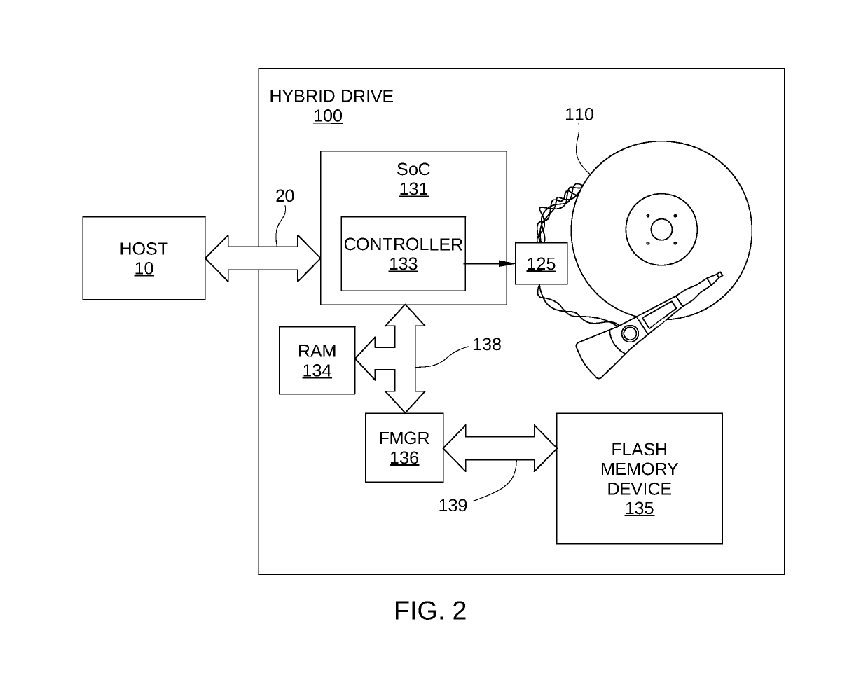

FIG. 2 illustrates an operational diagram of hybrid drive 100 with elements of electronic circuits 130 shown configured according to one embodiment. As shown, hybrid drive 100 includes RAM 134, flash memory device 135, a flash manager device 136, system-on-chip 131, motor-driver chip 125, and a high-speed data path 138. Hybrid drive 100 is connected to a host 10, such as a host computer, via a host interface 20, such as a serial advanced technology attachment (SATA) bus.

In the embodiment illustrated in FIG. 2, flash manager device 136 controls interfacing of flash memory device 135 with high-speed data path 138 and is connected to flash memory device 135 via a NAND interface bus 139. System-on-chip 131 includes microprocessor-based controller 133 and other hardware (including read/write channel 137) for controlling operation of hybrid drive 100, and is connected to RAM 134 and flash manager device 136 via high-speed data path 138. Microprocessor-based controller 133 is a control unit that may include a microcontroller such as an ARM microprocessor, a hybrid drive controller, and any control circuitry within hybrid drive 100. High-speed data path 138 is a high-speed bus known in the art, such as a double data rate (DDR) bus, a DDR2 bus, a DDR3 bus, or the like.

In general, data storage devices with magnetic storage media, such as disk drives, include a data buffer that has relatively small storage capacity compared to that of the magnetic storage media, i.e., on the order of a fraction of one percent of the magnetic media. In addition to storing write commands received by the disk drive, the data buffer can also be used to cache data that is most recently and/or most frequently used by a host device associated with the drive. When a host device requests access to a particular data block in the drive, having a larger memory cache reduces the likelihood of a “cache miss,” in which the more time-consuming process of retrieving data from the magnetic media must be used rather than providing the requested data directly from the data buffer. According to some embodiments, an integrated non-volatile solid-state memory, such as flash memory device 135 in hybrid drive 100, is configured for use as a very large data buffer. Because flash memory device 135 can have a storage capacity that is hundreds or thousands of times larger than that of RAM 134, many more cache entries are available, cache misses are much less likely to occur, and performance of hybrid drive 100 is greatly increased.

According to various embodiments, when flash memory device 135 is used to cache data of both read and write commands, the cached data in flash memory device 135 are tracked in a way that allows the determination to be made quickly as to whether a read or write command received by hybrid drive 100 is targeting a data storage location of data that is cached in flash memory device 135. Specifically, the addressable space of flash memory device 135 is partitioned into a plurality of equal sized logical segments, where each logical segment includes multiple logical blocks, e.g., 32 logical blocks, 64 logical blocks, 128 logical blocks, etc. Furthermore, the addressable user space of storage disk 110, representing the addressable space of a read command or a write command, is similarly partitioned into a plurality of equal sized sets of contiguous addresses, each set of contiguous addresses having the same size as a logical segment of flash memory device 135. When data associated with one of the sets of contiguous addresses are stored in flash memory device 135, physical memory locations in flash memory device 135 are allocated for said data and the set of contiguous addresses is mapped to a specific logical segment in flash memory device 135. In this way, the determination can be quickly made whether a specific logical block address (LBA), such as an LBA included in a write command, has a corresponding content stored in flash memory device 135.

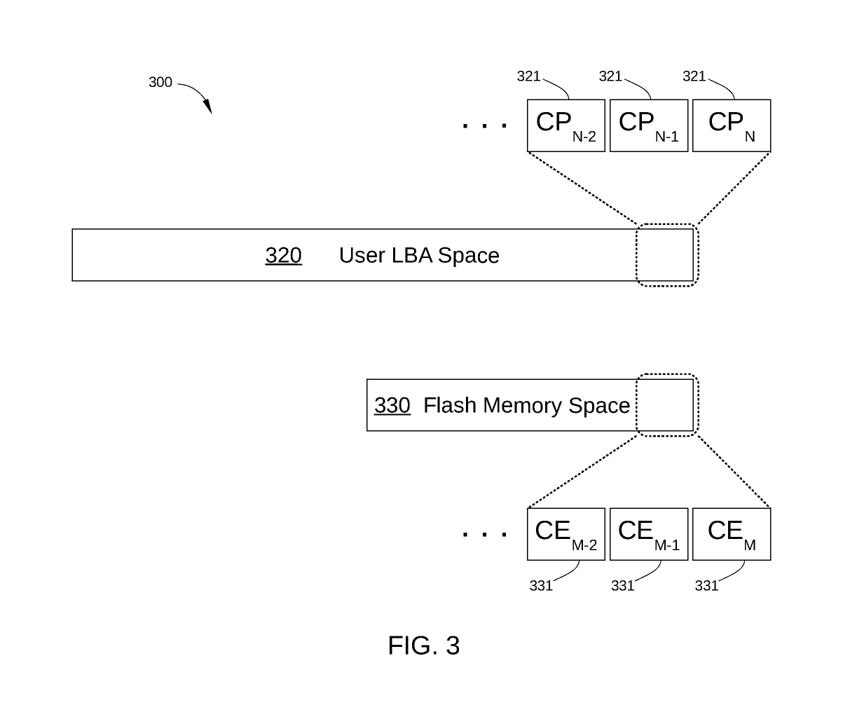

FIG. 3 is a conceptual illustration of a mapping structure 300, according to some embodiments. Mapping structure 300 includes a user LBA space 320 and a flash memory space 330. User LBA space 320 and flash memory space 330 are each addressable logical spaces, user LBA space 320 corresponding to the LBAs associated with storage disk 110 and flash memory space 330 corresponding to logical storage spaces associated with flash memory device 135. As shown, user LBA space 320 and flash memory space 330 are each partitioned into logical sub-units, which are described below.

User LBA space 320 includes the addressable user space of hybrid drive 100, and is partitioned into a number N of equal sized logical sub-units or segments, which are sets of contiguous addresses, referred to herein at cache pages 321. Thus each of cache pages 321 in user LBA space 320 includes a set of contiguous LBAs associated with the user space of hybrid drive 100, each cache page 321 having the same logical size, i.e., including the same number of LBAs. Furthermore, to facilitate mapping of data stored on storage disk 110 with corresponding data that may be stored in flash memory device 135, the logical size of each of cache pages 321 is also equal to the logical size of the logical sub-units into which flash memory space 330 is partitioned, which are referred to herein as cache entries 331.

Generally, there is a fixed relationship between LBAs in user LBA space 320 and cache pages 321. In other words, a particular LBA is associated with the same cache page 321 during operation of hybrid drive 100. In some embodiments, for ease of implementation, each LBA of user LBA space 320 is associated with a specific cache page 321 algorithmically. Thus, rather than consulting a table of all LBAs in user LBA space 320 to determine the cache page 321 with which a particular LBA is associated, an algorithm may be used to quickly make such a determination. For example, in an embodiment of mapping structure 300 in which each cache page 321 includes 64 LBAs, the appropriate cache page 321 for a particular LBA can be determined by dividing an address value associated with the LBA in question by 64, the quotient indicating the number of the appropriate cache page 321. Other algorithmic processes may also be used for determining the relationship between LBAs in user LBA space 320 and cache pages 321 without exceeding the scope of the invention.

Flash memory space 330 includes the addressable user space of flash memory device 135, and is partitioned into a number M of equal sized logical sub-units, referred to herein as cache entries 331. Each of cache entries 331 in flash memory space 330 has the same logical size as each of cache pages 321, i.e., each of cache entries 331 is configured to include the same number of LBAs as one of cache pages 321. Unlike cache pages 321, cache entries 331 are not permanently associated with a fixed set of contiguous LBAs. Instead, a particular cache entry 331 can be mapped to any one of cache pages 321 at any given time. Thus, when a different cache page 321 is mapped to the cache entry 331, a different group of LBAs are associated with the cache entry 331. During operation of hybrid drive 100, as data are evicted from flash memory device 135 for being used too infrequently by host 10 compared to other data, the cache page 321 associated with such evicted data is unmapped from the cache entry 331, so that a different cache page 321 can be mapped to the cache entry 331.

Generally, each of cache pages 321 and cache entries 331 includes multiple LBAs, for example 32 LBAs, 64 LBAs, 128 LBAs, or more. Consequently, partitioning LBA space 320 into cache pages 321 essentially re-enumerates the logical capacity of hybrid drive 100 using larger sub-units than the individual LBAs of LBA space 320. Because, according to various embodiments, mapping of data stored in flash memory device 135 is conducted using cache pages 321 and cache entries 331, tracking what LBAs are stored in flash memory device 135 can be performed much more quickly and using much less of RAM 134 than tracking whether or not each LBA in user LBA space 320 of storage disk 110 has a corresponding copy cached in flash memory device 135.

It is noted that, in theory, the size of cache pages 321 and cache entries 331 may be as small as a single LBA. In practice, however, the benefits of mapping data stored in flash memory device 135 using cache pages 321 and cache entries 331 is greatly enhanced when each cache page 321 and cache entry 331 includes a relatively large number of LBAs. Furthermore, determining which cache page 321 a particular LBA of interest is included in is greatly simplified when the number of LBAs included in each cache page 321 is a multiple of 2, i.e., 32, 64, 128, etc.

The number M of cache entries 331 in flash memory space 330 is generally much smaller than the number N of cache pages 321 in user LBA space 320, since the logical capacity of flash memory device 135 is generally much smaller than the logical capacity of storage disk 110. For example, the logical capacity of storage disk 110 may be on the order 1 TB, whereas the logical capacity of flash memory device 135 may be on the order of 10s or 100s of GBs. Thus, flash memory device 135 can only cache a portion of the data that are stored on storage disk 110. Consequently, one or more cache replacement algorithms known in the art may be utilized to select what data are cached in flash memory device 135 and what data are evicted, so that the data cached in flash memory device 135 are the most likely to be requested by host 10. For example, in some embodiments, both recency and frequency of data cached in flash memory device 135 are tracked, the oldest and/or least frequently used data being evicted and replaced with newer data or data that is more frequently used by host 10. As noted above, data are evicted from flash memory device 135 by unmapping the particular cache page 321 associated with the data to be evicted from the appropriate cache entry 331.

In some embodiments, a mapping function between cache pages 321 and cache entries 331 is used to efficiently track which LBAs in user LBA space 320 are stored in flash memory device 135. It is noted that data stored in flash memory device 135 and associated with a particular LBA in user LBA space 320 may be the only data associated with that particular LBA, or may be a cached copy of data associated with the LBA and stored on storage disk 110. In either case, for proper data management, the mapping function between cache pages 321 and cache entries 331 clearly indicates for any LBA in user LBA space 320 whether or not there is valid data associated with the LBA that is stored in flash memory device 135. In some embodiments, the mapping function is based on the number of cache entries 331 in flash memory space 330 and not on the number of cache pages 321 in user LBA space 320. In this way, determining whether or not a particular LBA has data corresponding thereto stored in flash memory device 135 can be quickly determined.

According to some embodiments, a B+ tree or similar data structure may be used for a mapping function between cache pages 321 and cache entries 331. A B+ tree data structure is a binary search tree with very high fanout, is well-suited to storage in block-oriented devices, and is also efficient when used with the synchronous dynamic random access memory (SDRAM) line cache that is available with modern microprocessors. Searching a B+ tree (or any binary tree) is an O(log(n)) operation, which means that the number of operations required to search grows only with the log of the number of cache entries 331. This is highly beneficial when flash memory device 135 includes a large number of cache entries 331. With one-half million cache entries 331, a B+ tree need to consult only about 5 nodes to search for a cache page 321, whether the search results in a hit or miss. Each “node consultation” is equivalent to about six table lookups, so the B+ tree gets an answer in about 30 operations instead of the one-quarter to one-half million operations needed to search a simple tabular mapping of cache pages 321 to cache entries 331. Because the data structure for constructing the mapping of cache pages 321 to cache entries 331 is typically too large to fit entirely in available SDRAM in RAM 134, the full data structure may be stored in flash memory device 135, while only the most recently accessed nodes of the B+ tree are cached in SDRAM. Alternatively, a hash function may be used to build a mapping of cache pages 321 to cache entries 331. Searching a hash is generally a O(1) operation, which means that the number of operations required to search is independent of the number of cache entries 331.

As noted above, according to some embodiments, a logical-to-physical mapping function is used to associate each cache entry 331 to physical locations (also referred to as “physical addresses”) in flash memory device 135. This logical-to-physical mapping function provides a mapping from a logical entity, i.e., a cache entry 331, to the physical address or addresses in flash memory device 135 that are associated with the cache entry 331 and used to store data associated with the cache entry 331. Because contemporary solid-state memory, particularly NAND, has an erase-before-write requirement, existing data cannot be overwritten in-place, i.e., in the same physical location, with a new version of the data. Thus, according to some embodiments, the logical-to-physical mapping function is configured to be updated when new data are written to flash memory device 135.

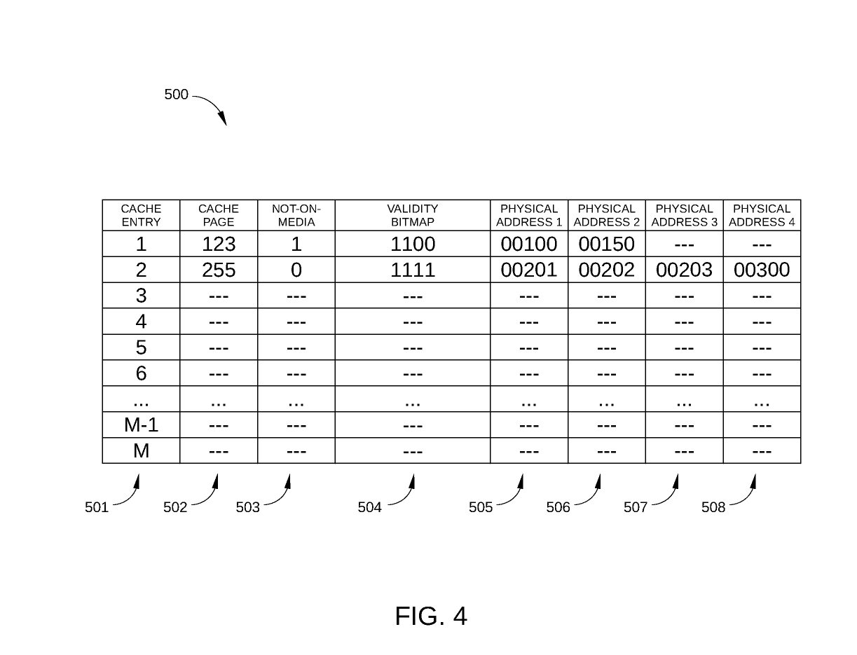

FIG. 4 is a tabular representation of a logical-to-physical mapping function 500 between cache entries 331 and physical addresses in flash memory device 135, according to some embodiments. While logical-to-physical mapping function 500 is described in terms of a tabular format in conjunction with FIG. 4, any other suitable data structure may be used to map cache entries 331 with physical addresses in flash memory device 135 without exceeding the scope of the invention.

In some embodiments, mapping function 500 returns a single physical address in flash memory device 135 for a particular cache entry 331 when the writable unit size (commonly referred to as “page size”) is equal to or greater than the size of a cache entry 331. In other embodiments, mapping function 500 can be configured to return a plurality of physical addresses when the writable unit size of flash memory device 135 is smaller than the size of cache entry 331. In such embodiments, a portion of a particular cache entry 331 may read from or written to. In the embodiment illustrated in FIG. 4, mapping function 500 is configured to indicate a plurality of physical addresses for each cache entry 331 that is mapped to one of cache pages 321 and is associated with data stored in flash memory device 135.

For clarity, in FIG. 4, four physical addresses are mapped to each of the M cache entries 331, each physical address may correspond to a unit of data associated with an LBA, such as a 512 byte sector. Thus, in such an embodiment, up to 2 kB of data are associated with each cache entry 331. In practice, having a larger number of physical addresses mapped to each of the M cache entries 331 is more beneficial. For example, when 64 physical addresses are mapped to a cache entry 331, each physical address corresponding to a 512 byte sector, each cache entry can have up to 32 kB associated therewith. Furthermore, in some embodiments, more than a single LBA can be associated with each of the physical addresses mapped to a particular cache entry 331. For example, for a cache entries 331 sized to accommodate 64 LBA, which is 32 kB of data, when the mapping unit (commonly the NAND page size or a multiple of the NAND page size) of flash memory device 135 is 8 kB in size, then four physical addresses are associated with each cache entry.

As shown, logical-to-physical mapping function 500 includes an entry in column 501 corresponding to each of the M cache entries 331 in flash memory device 135. For each cache entry 331, logical-to-physical mapping function 500 further includes a cache page entry in column 502, and one or more physical addresses (tracked in columns 505-508) in which data are stored that are associated with one or more LBAs mapped to a given cache entry 331. Logical-to-physical mapping function 500 may further include a not-on-media bit (tracked in column 503) and a validity bitmap (tracked in column 504).

In the embodiment illustrated in FIG. 4, there is a single not-on-media bit, which reflects the dirtiness of the data in flash memory device 135. If the most recent version of any data in a particular cache entry 331 is in flash memory device 135 and not on storage disk 110, then the not-on-media bit in column 503 is set. In addition, the validity bitmap in column 504 indicates which LBAs in a particular cache entry 331 have valid data in flash memory device 135. There is a bit in the validity bitmap for each LBA in the corresponding cache entry 331. In the embodiment illustrated in FIG. 4, four LBAs are associated with each cache entry 331. In an embodiment in which each cache entry 331 can be mapped to 64 LBAs, and therefore can include 32 kB of data, the validity bitmap in column 504 may include 64 bits. In some embodiments, for simplicity, each bit in the validity bitmap in column 504 may be associated with larger units of data than a 512 B LBA. For example, in some embodiments, each bit in the validity bitmap can be associated with a 4 kB block of data.

In the embodiment illustrated in FIG. 4, up to four physical addresses may be associated with a particular cache entry 331, so logical-to-physical mapping function 500 includes columns 505, 506, 507, and 508 for storing the associated physical addresses in flash memory device 135. For example, sufficient LBAs are mapped to cache entry 1 for two physical addresses of flash memory device 135 to be used, i.e., address 00100 in column 505 and address 00150 in column 506. No additional physical addresses are utilized for cache entry 1, so columns 507 and 508 have null values associated therewith. In the case of cache entry 2, sufficient LBAs are mapped to cache entry 2 for all possible physical addresses to be used, i.e., addresses 00201, 00202, 00203, and 00300, so all four of columns 505-508 include physical address entries. It is noted that for any particular cache entry 331, the physical addresses associated therewith are not necessarily contiguous physical address locations in flash memory device 135.

In some embodiments, the sum of the logical storage capacity of all cache entries 331 of flash memory device 135 is greater than the total data storage size of flash memory device 135. As shown for cache entry 1 in FIG. 4, a portion of cache entries 331 typically do not need all available physical locations to store data. Consequently, flash memory device 135 can have more cache entries 331 associated therewith than the total data storage size of flash memory device 135. In this way, more cache entries 331 are likely at any particular time to be available for mapping to cache pages 321, which facilitates operation of hybrid drive 100.

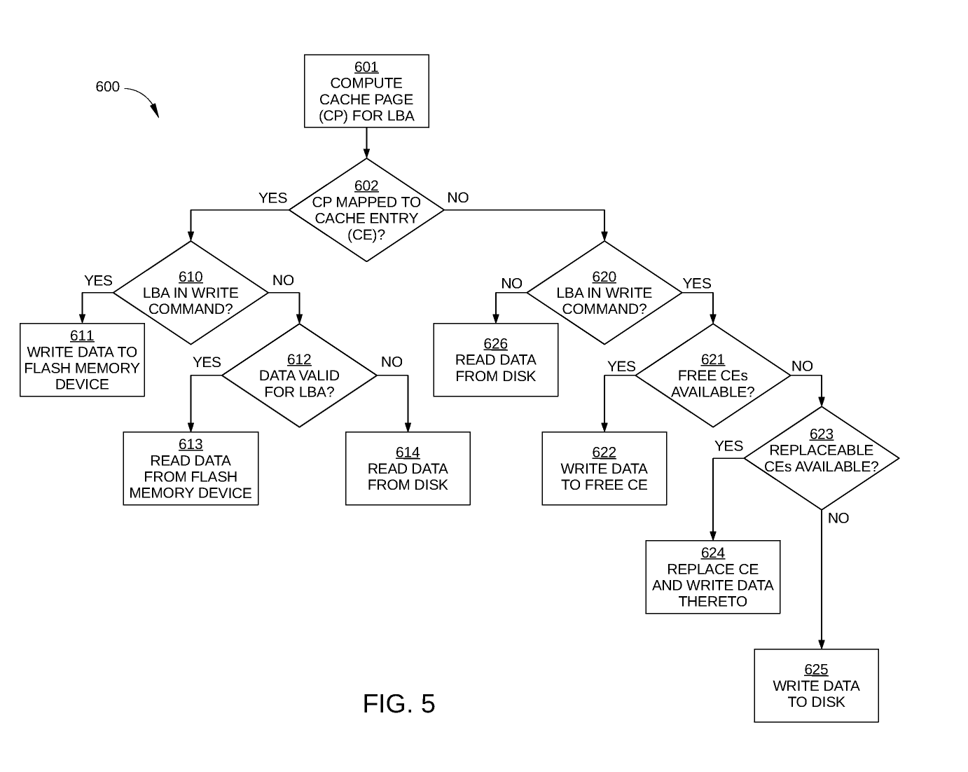

FIG. 5 sets forth a flowchart of method steps for data storage or retrieval in a hybrid drive, according to one or more embodiments. Although the method steps are described in conjunction with hybrid drive 100 in FIGS. 1-4, persons skilled in the art will understand that method 600 may be performed with other types of data storage systems. The control algorithms for method 600 may reside in and/or be performed by microprocessor-based controller 133, host 10, or any other suitable control circuit or system. For clarity, method 600 is described in terms of microprocessor-based controller 133 performing steps 601-626. Prior to method 600, hybrid drive 100 receives a read or write command that references one or more LBAs. Method 600 is then performed on each such LBA.

As shown, method 600 begins at step 601, where microprocessor-based controller 133 or other suitable control circuit or system computes the corresponding cache page 321 for the LBA of interest. In some embodiments, the computation performed in step 601 is a trivial computation involving dividing the LBA by the number of LBAs per cache page 321 in hybrid drive 100. When the number of LBAs per cache page 321 is a power of two, the division is simply a right-shift operation.

In step 602, microprocessor-based controller 133 determines whether or not the cache page 321 determined in step 601 is mapped to a cache entry 331. For example, mapping structure 300 can be consulted in the manner described above to make such a determination. If the cache page 321 of interest is mapped to cache entry 331, method 600 proceeds to step 610, and if the cache page 321 of interest is not mapped to cache entry 331, method 600 proceeds to step 620.

In step 610, microprocessor-based controller 133 determines whether the LBA of interest is associated with a write command or a read command. If the LBA is associated with a write command, method 600 proceeds to step 611. If the LBA of interest is associated with a read command, method 600 proceeds to step 612.

In step 611, in which the LBA is associated with a write command, microprocessor-based controller 133 controls the writing of data for the LBA of interest to the same cache entry 331 of flash memory device 135. However, new physical locations are used for writing said data, since flash memory device 135 generally does not allow in-place overwrite. In addition, because the most recent version of data associated with the LBA is now stored in flash memory device 135, microprocessor-based controller 133 sets the valid bit corresponding to the LBA. Furthermore, because the most recent version of data associated with the LBA exists solely in flash memory device 135 and not on storage disk 110, microprocessor-based controller 133 sets the not-on-media bit in step 611 as well. Method 600 then terminates.

In instances in which flash memory device 135 does not include available deleted memory blocks, a garbage collection process may be used to make sufficient deleted memory blocks available. Alternatively, data associated with the LBA may instead be written directly to storage disk 110.

In step 612, in which the LBA is associated with a read command, microprocessor-based controller 133 checks the value of the valid bit associated with the LBA. For example, such a bit may be located in a data structure similar to logical-to-physical mapping function 500. If said valid bit is set, i.e., the LBA is currently “valid,” then method 600 proceeds to step 613. If said valid bit is not set, i.e., the LBA is currently “invalid,” then method 600 proceeds to step 614.

In step 613, microprocessor-based controller 133 reads data associated with the LBA from the physical locations in flash memory device 135 mapped to the cache entry 331 to which the LBA is mapped. Method 600 then terminates.

In step 614, microprocessor-based controller 133 reads data associated with the LBA from storage disk 110, since there is not valid data associated with the LBA in flash memory device 135. Method 600 then terminates.

In step 620, in which no cache entry 331 is mapped to the cache page 321 that includes the LBA of interest, microprocessor-based controller 133 determines whether the LBA of interest is associated with a write command or a read command. If the LBA is associated with a write command, method 600 proceeds to step 621. If the LBA of interest is associated with a read command, method 600 proceeds to step 626.

In step 621, in which the LBA is associated with a write command, microprocessor-based controller 133 determines whether or not sufficient “free” cache entries 331 are available for storing data associated with the LBA. Free cache entries 331 are defined as cache entries 331 that are not currently mapped to a cache page 321. If sufficient free cache entries 331 are detected in step 621, method 600 proceeds to step 622. If insufficient free cache entries 331 are detected in step 621, method 600 proceeds to step 623.

In step 622, microprocessor-based controller 133 controls the writing of data for the LBA of interest to physical locations in flash memory device 135 associated with a free cache entry 331 detected in step 621. In addition, microprocessor-based controller 133 updates the mapping function between cache pages 321 and cache entries 331 accordingly, sets the valid bit, and sets the not-on-media bit.

In step 623, in which insufficient free cache entries 331 are available for writing data associated with the LBA, microprocessor-based controller 133 checks for availability of cache entries 331 that are mapped to a cache page 321, but are available for being replaced. For example, a cache entry 331 that is mapped to data that has a corresponding copy on storage disk 110, i.e., a cache entry 331 with a not-on-media bit that is not set, can be considered available for being replaced. If sufficient cache entries available for replacement are found in step 623, method 600 proceeds to step 624. If insufficient cache entries 331 available for replacement can be found in step 623, method 600 proceeds to step 625. It is noted that few or no cache entries 331 may be available for replacement when all cache entries 331 are currently in use and all or most cache entries 331 have the not-on-media bit set.

In step 624, microprocessor-based controller 133 selects one or more of the cache entries 331 found in step 623 available for replacement. Microprocessor-based controller 133 then removes the current mapping for the selected cache entry 331 and updates said mapping to the cache page 321 that includes the LBA, writes the data associated with the LBA to physical locations mapped to the selected cache entry, and sets the valid bit and the not-on-media bit for the LBA. Method 600 then terminates.

Various techniques may be used to select a cache entry 331 that is available for replacement. Generally, such a selection process includes a cache replacement algorithm that determines what data are least likely to be requested in the future by host 10. Many suitable cache replacement algorithms are known, including LRU, CLOCK, ARC, CAR, and CLOCK-Pro, and typically select a cache entry 331 for replacement based on recency and/or frequency of use of the data mapped thereto.

In step 625, in which no cache entries 331 are either free or available for replacement, microprocessor-based controller 133 controls the writing of data associated with the LBA to storage disk 110. Method 600 then terminates.

In step 626, in which the LBA of interest is associated with a read command and no cache entry 331 is mapped to the cache page 321 that includes said LBA, microprocessor-based controller 133 reads data associated with the LBA from storage disk 110. Method 600 then terminates.

In some embodiments, data read from storage disk 110 in response to a host command is subsequently written to flash memory device 135 for the purpose of caching said data in anticipation of future requests from host 10 for the data. In such embodiments, a modified version of method 600 can be used to implement such a data write procedure. For example, method 600 may be modified so that in step 622, the not-on-media bit is cleared instead of set, since an up-to-date copy of the data are also stored on storage disk 110. Similarly, in such embodiments, the not-on-media bit is not updated in step 624.

In some embodiments, during idle time or between host commands, microprocessor-based controller 133 may examine a suitable data structure, such as logical-to-physical mapping function 500, to determine which cache entries 331 have a not-on-media bit set. The data of the LBAs associated with such cache entries may be then be written to storage disk 110 so that the not-on-media bit can be cleared. In such embodiments, the writing of this data may be reordered to group writes that are on common or proximate tracks of storage disk 110 to improve performance of this writing operation. Because flash memory device 135 is typically much larger than RAM 134, and potentially a large number of cache entries 331 may include data to be reordered, such a writing operation can be greatly accelerated when performed by hybrid drive 100 compared to a convention hard disk drive with limited RAM for reordering writes.

In sum, embodiments described herein provide systems and methods for data storage and retrieval in a hybrid drive that includes a magnetic storage medium and an integrated non-volatile solid-state device. The addressable user space of the magnetic storage medium is partitioned into a number of equal sized sets of contiguous addresses, and the addressable space of the non-volatile solid-state storage device is partitioned into a plurality of equal sized logical segments. Storage is then allocated in the non-volatile solid-state device for selected sets of contiguous addresses of the magnetic storage medium by mapping each selected set of contiguous addresses to a specific logical segment in the non-volatile solid-state device. Advantageously, this mapping facilitates the use of the non-volatile solid-state device as a very large memory cache for the magnetic storage medium, which greatly improves performance of the hybrid drive.

While the foregoing is directed to embodiments of the present invention, other and further embodiments of the invention may be devised without departing from the basic scope thereof, and the scope thereof is determined by the claims that follow.

We claim:

1. A method of performing an operation on a data storage device including a non-volatile storage device and a magnetic storage device in response to a command to read or write a data block, the method comprising:
maintaining a mapping of an addressable space of the command to segments, the segments being partitioned from an addressable space of the non-volatile storage device and having equal size to each other that is bigger than a size of the data block, the addressable space of the command including an address of the data block;
determining from the mapping whether or not the address of the data block included in the command is mapped to one of the segments; and
executing the command based on said determining.

2. The method of claim 1, wherein each segment has a size that is a positive integer multiple of the size of the data block.

3. The method of claim 1, wherein, in response to determining that the address of the data block is not mapped to one of the segments, executing the command comprises reading the data block from the magnetic storage device, and in response to determining that the address of the data block is mapped to one of the segments, executing the command comprises reading the data block from the non-volatile storage device.

4. The method of claim 3, wherein reading the data block from the non-volatile storage device comprises reading the data block from a segment mapped to the address of the data block.

5. The method of claim 1, wherein, in response to determining that the address of the data block is mapped to one of the segments, executing the command comprises writing the data block to physical memory locations in the non-volatile storage device that are allocated to the one of the segments.

6. The method of claim 1, wherein, in response to determining that the address of the data block is not mapped to one of the segments, executing the command comprises:
mapping one of the segments to one of a plurality of unique sets of contiguous addresses that are in the addressable space of the command; and
writing the data block to physical memory locations in the non-volatile storage device that are allocated to the one of the segments.

7. The method of claim 6, wherein writing the data block to physical memory locations in the non-volatile storage device comprises allocating the physical memory locations to the one of the segments.

8. The method of claim 7, wherein allocating the physical memory locations comprises:
determining that insufficient physical memory locations are available in the non-volatile storage device; and
generating available physical memory locations in the non-volatile storage device by using at least one of a cache eviction process and a garbage collection process.

9. The method of claim 1, wherein the mapping defines how each of unique sets of contiguous addresses that are in the addressable space of the command are mapped to the segments.

10. The method of claim 9, wherein each of the unique sets of contiguous addresses has a size that is substantially equal to the size of a segment.

11. The method of claim 9, wherein the mapping of the addressable space of the command to the segments is based on the number of segments and not on the number of unique sets of contiguous addresses.

12. The method of claim 1, wherein a sum of the sizes of the segments is greater than a data storage size of the non-volatile storage device.

13. The method of claim 1, wherein the addressable space of the command is substantially larger than the addressable space of the non-volatile storage device.

14. A data storage device, comprising:
a magnetic storage device;
a non-volatile storage device; and
a controller configured to, in response to a command to read a data block:
maintain a mapping of an addressable space of the command to segments, the segments being partitioned from an addressable space of the non-volatile storage device and having equal size to each other that is bigger than a size of the data block, the addressable space of the command including an address of the data block; and
execute the command to read the data block based on whether or not the address of the data block is mapped to one of the segments.

15. The data storage device of claim 14, wherein the controller is further configured to, in response to determining that the address of the data block is not mapped to one of the segments, execute the read command by reading the data block from the magnetic storage device, and in response to determining that the address of the data block is mapped to one of the segments, execute the command to read the data block by reading the data block from the non-volatile storage device.

16. The data storage device of claim 14, wherein the mapping defines how each of unique sets of contiguous addresses that are in the addressable space of the command is mapped to the segments.

17. The data storage device of claim 16, wherein each of the unique sets of contiguous addresses has a size that is substantially equal to the size of a segment.

18. A data storage device, comprising:
a magnetic storage device;
a non-volatile storage device; and
a controller configured to, in response to a command to write a data block:
maintain a mapping of an addressable space of the command to the segments, the segments being partitioned from an addressable space of the non-volatile storage device and having equal size to each other that is bigger than a size of the data block, the addressable space of the command including an address of the data block; and
execute the command to write the data block based on whether or not the address of the data block is mapped to one of the segments.

19. The data storage device of claim 18, wherein the controller is further configured to, in response to determining that the address of the data block is mapped to one of the segments, execute the command to write the data block by writing the data block to physical memory locations in the non-volatile storage device that are allocated to the one of the segments.

20. The data storage device of claim 18, wherein the controller is further configured to, in response to determining that the address of the data block is not mapped to one of the segments, execute the command to write the data block by:
mapping one of the segments to one of a plurality of unique sets of contiguous addresses that are in the addressable space of the command; and
writing the data block to physical memory locations in the non-volatile storage device that are allocated to the one of the segments.
